(19) United States
(12) Patent Application Publication
(10) Pub. No.: US 2008/0034980 A1
(43) Pub. Date: Feb. 14, 2008

(54) Grilling implement for use in conjunction with a cooking Device

(75) Inventor: Moamar NARDONE, Quezon City - Manila (PH)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: Jennifer R. NARDONE, Quezon City (PH)

(21) Appl. No.: 11/836,168

(22) Filed: Aug. 9, 2007

(30) Foreign Application Priority Data
Aug. 10, 2006 (PH) PCT/PH2006/000018

(51) Int. Cl. A47J 37/04

(52) U.S. Cl. 99/419; 99/421 A; 99/427

(57) ABSTRACT

The present invention relates to a grilling implement for use in conjunction with a cooking device, preferably a griller having a pair of hinged grate components, comprising a base frame having an open top portion, an open bottom portion and a peripheral wall, stably seatable on an heating surface of said cooking device, wherein said peripheral wall has mounting means into which one or more grill accessories are suspendedly mounted. The grill accessories are preferably in forms of one or more suspendedly mounted skewers that are rotatably driven by at least a skewer driver that is mounted into said mounting means in a manner that said mover functions also as a handle for lifting said base frame, or of one or more clamp-type wire mesh grills suspendedly mounted into said mounting means through one or more mountable handles and tines thereof.

### TECHNICAL FIELD OF THE INVENTION

The present invention generally relates to cooking or culinary implements and more specifically to a grilling implement or food-handling device for use in conjunction with a cooking device, preferably a griller.

### BACKGROUND OF THE INVENTION

It is well known in the prior art to which this invention appertains that grilling is usually done on a grate of a griller. The problem with this practice is that the food that is being grilled often gets stuck onto the contact surface of the grate. This results in grilling inefficiency that most often produces unevenly cooked or grilled food. Although quite a number of grilling implements and/or accessories are already available in the market, they are not so designed to solve such problem as most of them are simply accessories enabling the griller to do other non-grilling cooking functions. There are attempts to resolve the problem, but they are focused more on improving the surface quality of the grate. One most common example for this is the provision of a non-stick surface on the grate. But still the problem has not been totally addressed since the solution creates other drawbacks such as low durability of the non-stick material, high cost of the product, and low ergonomic factor as there is a need to use special gadgets to prevent damage, e.g. scratching, of the non-stick coating on the grate.

Another drawback of the conventional grilling practice is the need to turn the grilled food upside down so that the ungrilled portion would be in contact with the grate. This action is cumbersome and undesirable for users, most especially if there is a plurality of grillable food pieces such as barbecues, fish and meat steaks, among others. It would also be unwieldy in grilling fishes whose skin often sticks onto the grate that requires the user to be extra careful in detaching and turning these fishes upside down to prevent the skin from stripping or peeling off.

There are prior art disclosures on grillers and their accessories such as McPeak's U.S. Pat. No. 2005/0279,223 and McGuire's U.S. Pat. No. 5,205,207 that are directed more to relatively more complex grillers and grilling implements/accessories. The former U.S. Patent relates to grill accessory that discloses and teaches suspendable hangers and adjustable supporting legs, while the latter relates to a multimodal rotisserie which is a complex griller assembly with accessories for mounting grillable food.

For reference to other prior art teachings on grilling implement, attention is also directed to Johnson's U.S. Pat. No. 5,823,589 relating to an accessory for charcoal grill which is simply a food-handling device with pivoting structure.

### SUMMARY OF THE INVENTION

The primary object of the present invention is to provide a grilling implement for use in conjunction with a cooking device that is capable of suspendedly holding the food to be grilled at a predetermined distance from the grate such that there would not be any contact between the food and the grate's surface during grilling. Hence, the problem of cooking or grilling inefficiency due to unwanted contact of the food with the grate is solved by the invention. Furthermore, the unwanted turning of grillable food items upside down, e.g. small meat pieces for barbecue and fishes, is likewise resolved as the present invention is capable of being axially rotated and turned upside down so easily and ergonomically.

The invention comprises of a base frame with open top and bottom portions bounded by peripheral wall that contains therein mounting means. This base frame is stably seatable on a griller's grate, and in turn facilitates the mounting of grill accessories such as motor-driven rotatable skewers and clamp-type wire mesh grill in a suspended manner.

It is therefore a primary object of the invention to provide a grilling implement for use in conjunction with a cooking device that is capable of grilling grillable food items suspendedly held therein at a predetermined distance from the grate or heat source through respective skewers that are rotatably driven by a skewer driver, both secured into mounting means of a base frame thereof, thus, producing well-cooked or uniformly grilled food items such as barbecues, steaks, fish fillets, chicken chips, among others.

Another object of the present invention is to provide a grilling implement for use in conjunction with a cooking device that is capable of efficiently grilling fishes and the like through the use of a clamp-type wire mesh grill having one or more mountable handles and tines suspendedly mounted into mounting means provided to a base frame thereof that is stably seated on a grate of a griller.

Still another object thereof is to provide a grilling implement for use in conjunction with a cooking device that has the base frame thereof containing the grillable food in skewers, capable of being manually lifted off or taken away from the grate by simply taking hold of the skewer driver hookedly mounted into said frame, especially when flames occur during grilling process.

Other objects and advantages of the present invention will become apparent, understood and appreciated upon reading the following detailed description taken in conjunction with the accompanying drawings, in which:

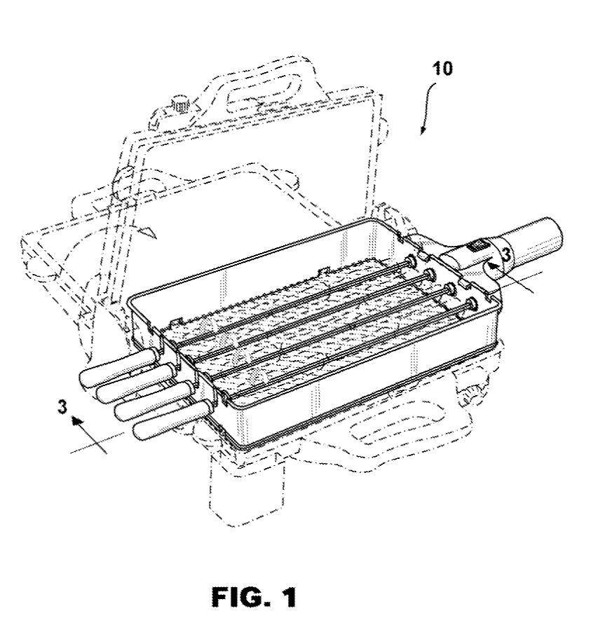

FIG. 1 is a perspective view of a preferred embodiment of the present invention;

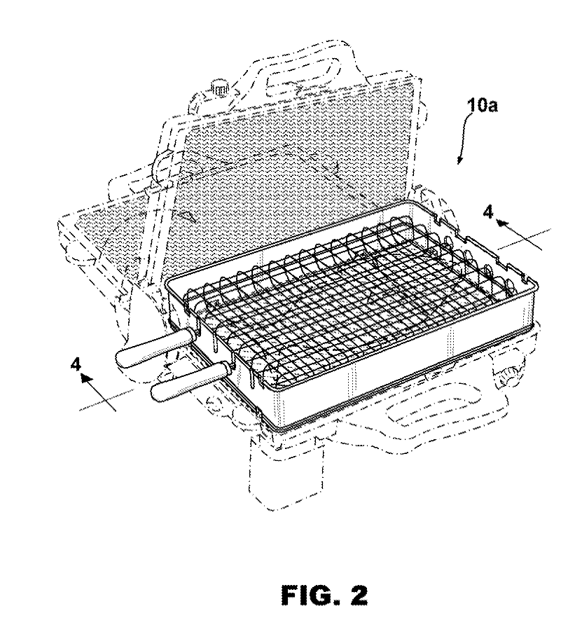

FIG. 2 is a perspective view of another preferred embodiment thereof;

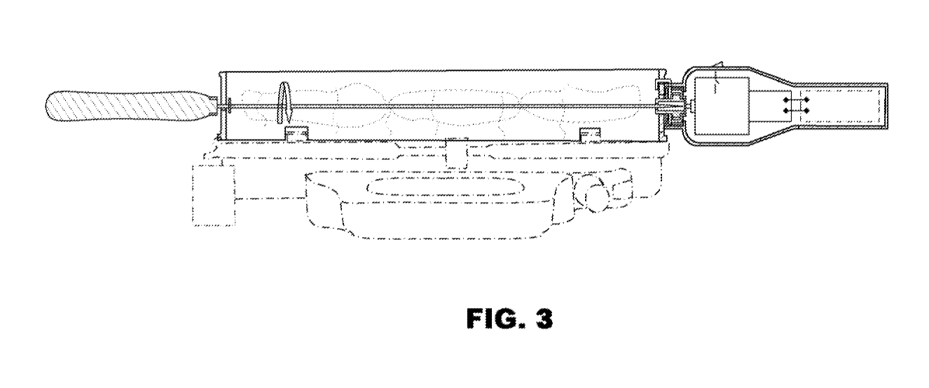

FIG. 3 is a cross-sectional view thereof taken along line 3-3 of FIG. 1;

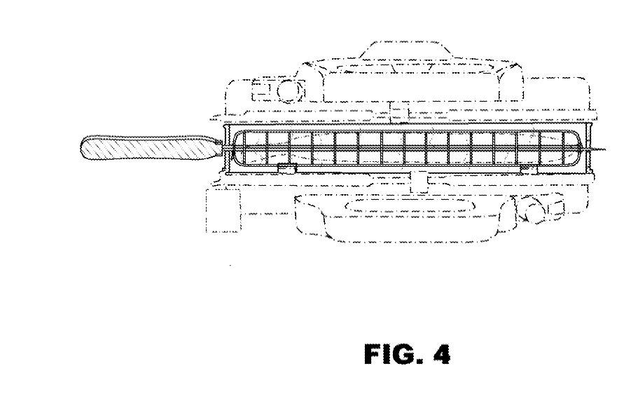

FIG. 4 is a cross-sectional view thereof taken along line 4-4 of FIG. 2;

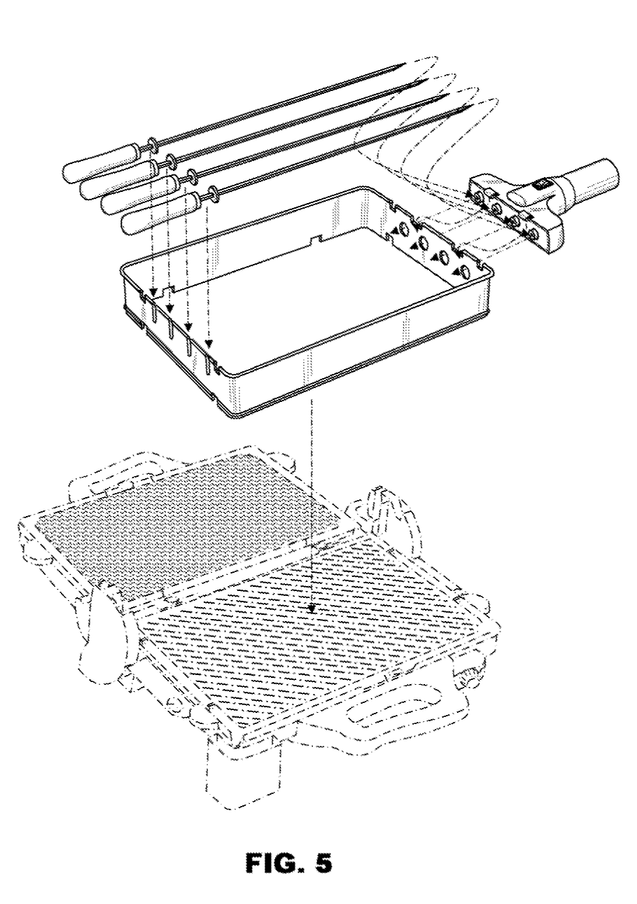

FIG. 5 is an exploded, perspective view thereof as referred to FIG. 1; and

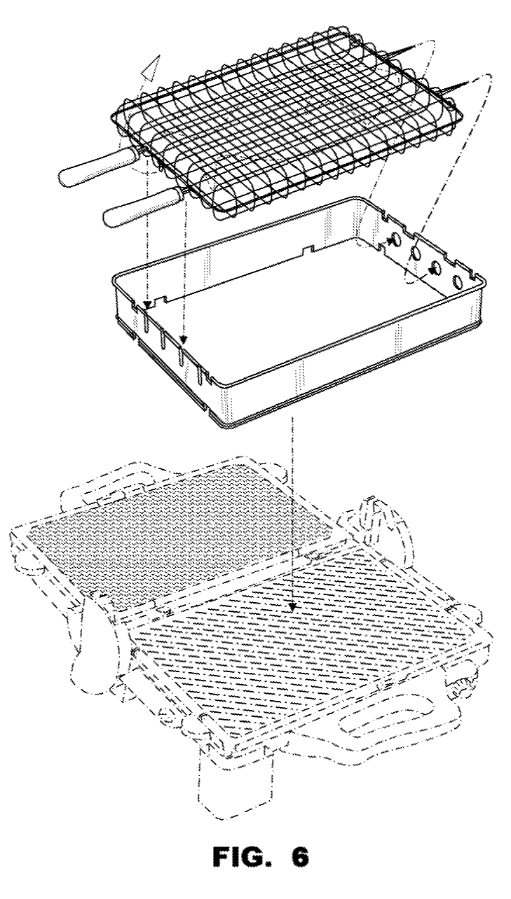

FIG. 6 is an exploded, perspective view thereof as referred to FIG. 2.

### DETAILED DESCRIPTION OF THE INVENTION

Before describing the preferred embodiments of the invention in detail, it is to be understood that the phraseologies and terminologies employed herein are for purposes of description and should not be regarded as limiting.

Referring now to the drawing in which like reference numerals designate the same components or elements all throughout the succeeding description, there is shown in FIG. 1 a grilling implement for use in conjunction with a cooking device generally designated by reference numeral 10 comprising a base frame 11 having an open top portion 12, an open bottom portion 13 and a peripheral wall 14, stably seatable on an heating surface 15 of a cooking device 16, preferably a grate 27 of a griller 25. The peripheral wall 14 has mounting means 17 into which at least one grill accessory 18 is suspendedly mounted, and into which anchor lugs and protuberances 25a on the grate's surface are engaged for mounting stability of the base frame 11 onto the grate 27.

The mounting means 17 is preferably in forms of one or more aligned notches 19 and apertures 20 and combination thereof oppositely provided at the peripheral wall 14. In the illustrative example herein disclosed, the notches 19 are spacedly provided at the upper portion of the peripheral wall 14 at the transverse sides, wherein one group of notches 19a is to accommodate, one at a time, the mounting of one or more skewers 21 and clamp-type wire mesh grill 22a (FIG. 2) proximate the handles thereof, and another group of notches 19b at the opposite side is to facilitate the engagement of respective attaching means 29, preferably in a form of hook members 30, provided at the upper front end portion of a skewer driver 22. The apertures 20 are spacedly provided at the mid section of the peripheral wall 14 at the opposite transverse side in alignment with the notches 19a at the opposite side, to accommodate mounting of respective slotted spindles 31a of gears 31 (FIG. 3) provided at the front section of the driver 22.

The grill accessory 18 is preferably in forms of the above-mentioned one or more skewers 21 (generally accessory 18a), or clamp-type wire mesh grill 22a (generally accessory 18b) having one or more mountable handles 23 and tines 24. The skewers 21, preferably with a polygonal cross-section such as square or rectangular profile, have the pointed end portions 21a thereof (as shown in FIG. 3) lockably engaged with and rotatably driven, through respective gear slots 32 with same profile, by at least one of skewer driver 22 that is mounted on the mounting means 17 in a manner that the skewer driver 22 functions also as a handle for lifting the base frame 11. The skewers 21 are each provided with a handle 21b. The skewer driver 22 comprises of the gears 31 driven by a prime mover, preferably a motor unit 33 with a speed reducer, and intermediate gears (not shown) for rotational uniformity in terms of speed and direction. The motor unit 33, which is turned on or off by a switch 35, is preferably powered by a battery 34, or as options, a power source via an adaptor (not shown) or an electrical power outlet means (not shown) provided to the griller 25 wherein a corresponding plug or switch (not shown) provided to the driver 22 automatically engages or connects when mounted in place. All elements of the skewer driver 22 are contained in a housing 36 thereof having a generally elongated rear portion 37 that is of sufficient size just enough to facilitate a hand grip for convenient lifting or carrying thereof and the entire assemblage of the base frame 11 during grilling, especially when a flame occurs.

The cooking device 16 is preferably the griller 25 of a type having a pair of hinged grate components 26a and 26b on which the grilling implement 10 or base frame 11 is stably seated when the griller 25 is in an open position. When a single grilling implement 10 is in use, it is preferably interposed by the grate components 26a and 26b, with the covering grate component 26a at the top position as shown in FIG. 4. The grate component 26a is preferably provided with a grate 27 made of screen material 28. This screen material 28 is a more effective and efficient heat transfer medium than the grate plate 27a (shown in FIG. 6) which is an opaque material, especially for non-contact grilling as taught by the invention. Preferably, the screen material 28 is made of stainless steel or aluminum wire mesh of sufficient mesh sizes just enough to allow radiating heat from the griller's heating element to effectively pass through.

Shown in FIGS. 1, 3 and 5 is a preferred embodiment of the invention in form of a combination 10a of the grilling implement 10 comprising the base frame 11; the griller 25 having the pair of hinged grate components 26a and 26b on which the base frame 11 is stably seated; and the grill accessory 18a in a form of one or more suspendedly mounted skewers 21 that are rotatably driven by the skewer driver 22 mounted into the mounting means 17 in a manner that the skewer driver 22 functions also as the handle for lifting the base frame 11.

Shown in FIGS. 2, 4 and 6 is another preferred embodiment of the invention in form of another combination 10b of the grilling implement 10 comprising the base frame 11; the griller 25 having the pair of hinged grate components 26a and 26b on which the base frame 11 is stably seated, wherein when a single grilling implement 10 or base frame 11 is in use, the latter is interposed by the grate components 26a and 26b, with the covering grate component 26a at the top position having the grate 27 made of screen material as earlier mentioned; and the grill accessory 18b in a form of one or more clamp-type wire mesh grills 22a suspendedly mounted into the mounting means 17 through the mountable handles 23 and tines 24 thereof. The clamp-type wire mesh grill 22a comprises of a pair of hinged wire mesh clamping members 38 provided with the respective handles 23 at the distal end portion thereof opposite the tines 24. In usage, the grillable food items “F”, e.g. fish and meat, is interposed and clamped in between the members 38 and locked in place therein by a locking means 39.

To use or operate the invention, the base frame 11 is first stably mounted or seated on the heating surface 15, preferably on the grate 27, after the cooking device 16, preferably the griller 25, is opened half way with the grate component 26a in an upstanding vertical position or totally with the grate component 26a in an horizontal position as shown by an arrow “G” in FIGS. 1 and 2. For using the skewers 21, the skewer driver 22 is then hookedly and fittingly mounted into the respective notches 19b and apertures 20 of the base frame 11 as shown by invisible arrows “B” in FIG. 5. The skewers 21 containing already the grillable food items “F” are then conveniently inserted into corresponding gear slots 32 (shown by arrows “C” in FIG. 5), while the other end portions thereof proximate their respective handles 21b are mounted into the corresponding notches 19a (shown by arrows “D” in FIG. 5). The griller 25 and skewer driver 22 are turned on. The skewers 21 then rotate as shown by arrows “A”. Hence, the grilling process using skewers 21 commences. On the other hand, for opting to use the clamp-type wire mesh grill 22a, the grill 22a is first opened (shown by arrow “H”) using the handles 23 thereof to accommodate the grillable food item “F” therein that is then clamped by clamping members 38. After locking clamping members 38 together, the grill 22a is then positioned in place by inserting the tines 24 into corresponding apertures 20 of the base frame 11 as shown by arrows “E” in FIG. 6, while mounting the other end portions thereof proximate the handles 23 into the respective notches 19a. With this set-up where the grill 22a is suspendedly seated on the base frame 11, the grilling process commences with the switching-on of the griller 25 and covering the grill 22a with the grate component 26a that is provided with the screen material 28 in lieu of the grate plate 27a as shown in FIG. 6.

Before defining the scope of the following claims, it is to be understood that the invention is not limited in its applications to the details of the embodied system and method set forth in the preceding description or illustrated in the drawings. It is to be noted that the invention is capable of other embodiments and limitless applications not disclosed herein, and of being practiced and carried out in various ways falling within the teaching and scope of the following claims.

What is claimed is:

1. A grilling implement for use in conjunction with a cooking device comprising a base frame having an open top portion, an open bottom portion and a peripheral wall, stably seatable on an heating surface of said cooking device, wherein said peripheral wall has mounting means into which at least one grill accessory is suspendedly mounted.

2. A grilling implement according to claim 1 wherein said mounting means is in a form selected from one or more aligned notches and apertures and combination thereof.

3. A grilling implement according to claim 1 wherein said grill accessory is in a form of one or more skewers.

4. A grilling implement according to claim 3 wherein said skewers are rotatably driven by at least one skewer driver that is mounted on said mounting means in a manner that it functions also as a handle for lifting said base frame.

5. A grilling implement according to claim 1 wherein said grill accessory is in a form of a clamp-type wire mesh grill having one or more mountable handles and tines.

6. A grilling implement according to claim 1 wherein said cooking device is a griller of a type having a pair of hinged grate components on which said grilling implement is stably seated, wherein when a single said grilling implement is in use, it is interposed by said grate components, with the covering grate component at the top position having a grate made of screen material.

7. In combination, a grilling implement comprising a base frame having an open top portion, an open bottom portion and a peripheral wall, stably seatable on an heating surface of said cooking device, wherein said peripheral wall has mounting means in forms of oppositely aligned notches and apertures for suspending at least one grill accessory; a griller having a pair of hinged grate components on which said grilling implement is stably seated; and a grill accessory in a form of one or more suspendedly mounted skewers that are rotatably driven by at least a skewer driver that is mounted into said mounting means in a manner that said mover functions also as a handle for lifting said base frame.

8. In combination, a grilling implement comprising a base frame having an open top portion, an open bottom portion and a peripheral wall, stably seatable on an heating surface of said cooking device, wherein said peripheral wall has mounting means in forms of oppositely aligned notches and apertures for suspending at least one grill accessory; a griller having a pair of hinged grate components on which said grilling implement is stably seated, wherein when a single said grilling implement is in use, it is interposed by said grate components, with the covering grate component at the top position having a grate made of screen material; and a grill accessory in a form of one or more clamp-type wire mesh grills suspendedly mounted into said mounting means through one or more mountable handles and tines thereof.
